(19) United States
(12) Patent Application Publication
(10) Pub. No.: US 2010/0149510 A1
(43) Pub. Date: Jun. 17, 2010

(54) METHODS FOR PRODUCING AN ANTIREFLECTION SURFACE ON AN OPTICAL ELEMENT, OPTICAL ELEMENT AND ASSOCIATED OPTICAL ARRANGEMENT

(75) Inventors: Christoph ZACZEK, Heubach (DE); Gennady FEDOSENKO, Aalen (DE); Wolfgang HENSCHEL, Unterschneidheim (DE); Daniel KRAEHMER, Essingen (DE)

Correspondence Address: SUGHRUE MION, PLLC, 2100 PENNSYLVANIA AVENUE, N.W., SUITE 800, WASHINGTON, DC, 20037, US

(73) Assignee: Carl Zeiss SMT AG, Oberkochen (DE)

(21) Appl. No.: 12/631,536

(22) Filed: Dec. 4, 2009

Related U.S. Application Data
(63) Continuation of application No. PCT/EP2008/003987, filed on May 19, 2008.
(60) Provisional application No. 60/942,157, filed on Jun. 5, 2007.

(30) Foreign Application Priority Data
May 19, 2008 (EP) PCT/EP2008/003987

(51) Int. Cl. G03B 27/72; G02B 1/11; B05D 5/06

(52) U.S. Cl. 355/71; 359/589; 359/359; 216/24

(57) ABSTRACT

Methods for producing an antireflection surface (6) on an optical element (1) made of a material that is transparent at a useful-light wavelength λ in the UV region, preferably at 193 nm. A first method includes: applying a layer (3) of an inorganic, non-metallic material, which forms nanostructures (4) and is transparent to the useful-light wavelength λ, onto a surface (2) of the optical element (1); and etching the surface (2) while using the nanostructures (4) of the layer (3) as an etching mask for forming preferably pyramid-shaped or conical sub-lambda structures (5) in the surface (2). In a second method, the sub-lambda structures are produced without using an etching mask. An associated optical element (1) includes such an antireflection surface (6), and an associated optical arrangement includes such an optical element (1).

### CROSS-REFERENCE TO RELATED APPLICATIONS

This is a Continuation of International Application PCT/EP2008/003987, with an international filing date of May 19, 2008, which was published under PCT Article 21(2) in English, and the complete disclosure of which, including amendments, is incorporated into this application by reference; this application also claims the benefit under 35 U.S.C. 119(e)(1) of U.S. Provisional Application No. 60/942,157, filed Jun. 5, 2007. The disclosure of U.S. Provisional Application No. 60/942,157, filed Jun. 5, 2007, is considered part of and is incorporated by reference in the disclosure of the present application.

### FIELD OF THE INVENTION

The invention relates to methods for producing an antireflection surface on an optical element, to an optical element comprising an antireflection surface, as well as to an optical arrangement comprising at least one optical element having such an antireflection surface.

Reducing reflections on surfaces of optical elements is of great interest in a multitude of different optical applications. To this end, antireflection coatings based on multilayer systems with alternating layers of high-refraction and low-refraction materials are commonly used, which antireflection coatings produce an antireflection effect as a result of interference effects. Such antireflection coatings are associated with a disadvantage in that in the case of high angles of incidence, of typically more than 60°, due to the required considerable coating thickness of the multilayer system, increased absorption and thus a considerable reduction in transmission occurs. Furthermore, in the case of high angles of incidence, strong polarization splitting of the incident light occurs, both in phase and in intensity. In addition, unfavorable phenomena such as birefringence or variations in the refractive index can occur along the surface coated with the multilayer system.

In order to prevent the above-mentioned difficulties it is known to implement antireflection surfaces by means of gradient layers whose refractive index decreases continuously from the surface of the optical element towards the surrounding medium. In this way, it is also possible to achieve a reduction in reflection. While such gradient layers can be generated by suitable surface coating methods, this is, however, associated with considerable expenditure and frequently does not produce the desired effect in every case, namely that of a significant reduction in reflection. Therefore, more recently, attempts have been made to approximate a gradient layer in that the surfaces of optical elements are provided with structures whose structural sizes or structural widths are below the wavelength of the radiation impinging upon the optical element, which structures are hereinafter referred to as sub-lambda structures.

In order to prevent the occurrence of stray light the sub-lambda structures are ideally evenly distributed over the surface. The form of the sub-lambda structures which result in an ideal gradient layer, i.e. an antireflection surface with significantly reduced reflection, depends among other things on the refractive index of the material of the optical element, which material is used as a substrate. Examples of such structures are described in the article “Pyramid-array surface-relief structures producing antireflection index matching on optical surfaces” by W. H. Southwell, J. Opt. Soc. Am. A, vol. 8, no. 3, 1991, pages 549 to 553. The article shows that arrays comprising three-dimensional pyramidal structures or conical structures are particularly well suited to producing an ideal gradient layer.

In order to produce an antireflection surface that comprises a surface relief with sub-lambda structures, from US 2006/0024018 A1 it is known to apply onto the surface of the optical element, which surface is to be structured, a coating of a material which by way of self-organisation forms nanostructures whose structural-width distribution occurs as a result of a self-organisation process. The nanostructured material is used as an etching mask for etching the underlying surface and to this effect can, for example, form hole-shaped nanostructures on the surface. At the holes in the nanostructured coating the underlying surface is etched particularly strongly so that a surface relief with sub-lambda structures forms, which structures are to assume the faun described above. Polymers, such as PMMA, or metals, in particular gold, are examples of nanostructure-forming coating materials that can be used as etching masks.

The method for producing an antireflection surface, which method is described in US 2006/0024018 A1, is suitable for useful wavelengths in the visible range. In the use of optical elements in microlithography, in which the useful-light wavelength is in the UV region, for example at a wavelength of 193 nm, the sub-lambda structures have to have significantly narrower structural widths. In an antireflection surface produced according to the method described above, while frequently a reduction in the reflection has been achieved, at the same time an increase in the absorption of the optical element has also been experienced.

### OBJECTS AND SUMMARY OF THE INVENTION

It is an object of the invention to provide a method for producing an antireflection surface on an optical element, which element can be operated at a wavelength λ, of the useful light in the UV region, as well as an optical element comprising an antireflection surface and an optical arrangement comprising such an optical element.

According to one formulation of the invention, this object is met by a method for producing an antireflection surface on an optical element made of a material that is transparent at a useful-light wavelength λ in the UV region, preferably at 193 nm, with the method comprising the steps of: applying a layer of an inorganic non-metallic material, which forms nanostructures and is transparent to the useful-light wavelength λ, onto a surface of the optical element; and etching the surface with the use of the nanostructures of the layer as an etching mask for forming preferably pyramid-shaped or conical sub-lambda structures in the surface.

In contrast to US 2006/0024018 A1, in a method according to the invention a material that forms nanostructures is selected that is transparent at a useful-light wavelength in the UV region. The inventors have found that while the nanonstructure-forming layer in theory is completely etched away, in practical applications nevertheless, after etching, residues of the etched-away layer still remain on the antireflection surface. Thus the use of materials that are non-transparent to the useful light, for example metals, as coating materials is associated with a disadvantage in that the incident light is partly absorbed by the metal particles that remain on the surface after etching, which partly counteracts the desired effect, namely to achieve the best possible light yield with the antireflection surface.

Furthermore, if the optical elements are used in optical arrangements such as projection exposure apparatuses for microlithography, remaining metal particles can very easily diffuse out and precipitate at undesirable locations, which is unfavorable in particular in the case of optical elements that are situated close to the wafer, for example in the case of closing plates.

In a particularly preferred variant, a dielectric material, preferably a metal fluoride or metal oxide, is selected as a material that forms the nanostructures. When a coating of a dielectric material is applied to a surface, said surface as a rule does not grow as a homogeneous coating but instead forms nanostructures, which can, for example, have a columnar structure. The column diameters of the nanostructures that form in this process depend on several parameters during the application of the coating, wherein said column diameters can be significantly below the useful-light wavelength. If coating materials with columnar structures are used as an etching mask, the positions between the columns form natural etching channels along the grain boundaries so that the surface of the optical element at the positions between the columns is preferentially etched away, and in this way the desired surface relief can be created.

In an advantageous variant the material that forms the nanostructures is selected from the group consisting of: magnesium fluoride (MgF₂), neodymium fluoride (NdF₃), lanthanum fluoride (LaF₃), erbium fluoride (ErF₃), cryolite (Na₃AlF₆), chiolite (Na₅Al₃F₁₄), gadolinium fluoride (GdF₃), aluminium fluoride (AlF₃) and aluminium oxide (Al₂O₃). Due to their intrinsic structure during growing, these materials are particularly suited as layer materials.

In a further advantageous variant the layer is applied to the surface of the optical element by vapor deposition, wherein at least one vapor deposition parameter, preferably a vapor deposition angle, a vapor deposition rate and/or a vapor deposition temperature are/is selected such that a desired distribution of structural widths of the nanostructures is obtained. As a rule, the smaller the vapor deposition angle selected, the narrower is the structural-width distribution. The form of the structural width distribution, and if applicable of the nanostructures, can also be influenced by further vapor deposition parameters, for example by the vapor deposition temperature and the vapor deposition rate.

In a preferred variant the vapor deposition parameter/s is/are selected such that a structural-width distribution results in which less than 1%, preferably less than 0.5%, in particular less than 0.1% of the nanostructures comprise a structural width that is above the useful-light wavelength λ, preferably above half the useful-light wavelength λ/2. In an ideal case the structural widths of all nanostructures are below half the useful-light wavelength λ/2, in particular below 0.4λ. In this way sub-lambda structures can be generated that provide a good antireflection effect even at high angles of incidence.

In a further particularly advantageous variant, etching of the applied layer takes place by preferably directed plasma etching or ion beam etching. Using anisotropic etching, even when etching isotropic materials, structures with an aspect ratio greater than one can be produced, i.e. structures with a structural height that exceeds their structural width. In the case of anisotropic etching, a plasma beam or ion beam is directed onto the surface to be processed.

The invention is also implemented in a method for producing an antireflection surface on an optical element made of a material that is transparent at a useful-light wavelength λ in the UV region, preferably at 193 nm, the method comprising the steps of: plasma- or ion beam etching of a surface of the optical element in a gas atmosphere, preferably in a directed way, wherein the antireflection surface is produced by forming three-dimensional, preferably pyramid-shaped or conical, structures in the surface. In contrast to the method described above, in this case no coating that serves as an etching mask is applied to the surface. The inventors have found that sub-lambda structures are formed on a surface of an optical element by self-organisation during preferably plasma-enhanced anisotropic etching in a suitable gas atmosphere.

In a preferred variant the gas atmosphere is formed by at least one gas selected from the group consisting of: fluorine (F₂), hydrogen fluoride (HF), sulphur hexafluoride (SF₆), xenon difluoride (XeF₂), nitrogen trifluoride (NF₃) and perfluorinated hydrocarbons, in particular tetrafluoromethane (CEO, hexafluorethane (C₂F₆) and hexafluorobutadiene (C₄F₆). A gas atmosphere comprising the gases stated above promotes the formation of sub-lambda structures.

In a further advantageous variant the pressure of the gas atmosphere is selected to be between 10⁻¹ mbar and 10⁻⁶ mbar, preferably between 10⁻³ mbar and 10⁻⁴ mbar. Selecting a suitable pressure of the gas atmosphere also contributes to forming the sub-lambda structures.

In a particularly advantageous variant the temperature of the gas atmosphere is selected to be between 15° C. and 400° C., preferably between 20° C. and 200° C. The temperature during etching also has an influence on the form and size of the sub-lambda structures.

In a particularly preferred variant, during etching with or without an etching mask, an etching gas is selected from the group comprising: fluorine (F₂), hydrogen fluoride (HF), sulphur hexafluoride (SF₆), xenon difluoride (XeF₂), nitrogen trifluoride (NF₃) and perfluorinated hydrocarbons, in particular tetrafluoromethane (CF₄), hexafluorethane (C₂F₆) and hexafluorobutadiene (C₄F₆). Such etching gases are particularly suited to the etching of materials that are transparent to UV light, e.g. for etching fused silica.

In a particularly advantageous variant sub-lambda structures are produced with a structural width of 100 nm or less, preferably of 80 nm or less. Sub-lambda structures comprising a structural width in particular of below 80 nm are suitable for reducing reflections of surfaces even at high angles of incidence of up to 50° or up to 70°. The shape of the sub-lambda structures is not limited to pyramid structures or conical structures, for example it is also possible to form hemispherical sub-lambda structures in order to approximate an ideal gradient coating. However, structures with steeply dropping flanks, e.g. cuboid structures, should be avoided in order to ensure a continuous transition of the refractive index between the surface of the optical element and the surrounding medium.

In a further advantageous variant the sub-lambda structures are produced with a structural height of 100 nm or more, preferably of 180 nm or more, particularly preferably of 240 nm or more. It is advantageous if the aspect ratio of the structures produced is greater than 1. With a structural width of 80 nm, at a useful-light wavelength of 193 nm, a good reflection-reducing effect can be achieved up to angles of incidence of approximately 50° if at a structural width of 80 nm a structural height of 100 nm is selected (aspect ratio 1.25). Correspondingly, with a structural height of approx. 240 nm (aspect ratio 3) a good reflection-reducing effect up to angles of incidence of approximately 60° can be achieved. With a further increase in the aspect ratio, the reflection-reducing effect can be improved still further.

In a preferred variant, at an angle of incidence of 50° or less, preferably of 60° or less, the antireflection surface comprises a reflectivity of less than 1%, preferably of less than 0.5%, for radiation at the useful-light wavelength λ. Such a reflection-reducing effect can be achieved with structures that are dimensioned as described above.

In a further advantageous variant fused silica (SiO₂) is selected as the material of the optical element. Due to its materials characteristics this material is particularly suited to the production of antireflection surfaces using the method described above.

The invention is further implemented in an optical element for a useful-light wavelength λ, in the UV region, preferably at 193 nm, comprising at least one antireflection surface, with preferably pyramid-shaped or conical sub-lambda structures, which antireflection surface is, in particular, produced according to one of the methods described above. Preferred embodiments of the optical element comprise antireflection surfaces that comprise sub-lambda structures with the characteristics presented above, which antireflection surfaces thus achieve the reflection-reducing effect as presented above. Advantageously, at least one such optical element is arranged in an optical arrangement, preferably in a projection exposure apparatus for microlithography, so that the useful-light fraction in such an apparatus can be increased and, in particular, polarization-dependent differences in the degree of transmission can be reduced.

Further characteristics and advantages of the invention are provided in the following description of exemplary embodiments of the invention, with reference to the figures in the drawing, which figures show details that are significant in the context of the invention, and in the claims. The individual characteristics can be implemented individually, or several of them can be implemented in any desired combination in a variant of the invention.

### BRIEF DESCRIPTION OF THE DRAWINGS

Exemplary embodiments are shown in the diagrammatic drawing and are explained in the description below. The following are shown:

FIGS. 1a-c diagrammatic views of method-related steps of a first method according to the invention for producing an antireflection surface using an etching mask;

FIGS. 2a,b diagrammatic views of method-related steps of a second method according to the invention for producing an antireflection surface, without a mask;

FIGS. 3a,b structural-width distributions of nanostructures of a coating that serves as an etching mask in the method according to FIGS. 1a-c, with different vapor deposition parameters; and

FIG. 4 a scanning electron microscope image of a fused silica surface after anisotropic etching in the method according to FIGS. 2a,b.

### DETAILED DESCRIPTION OF PREFERRED EMBODIMENTS

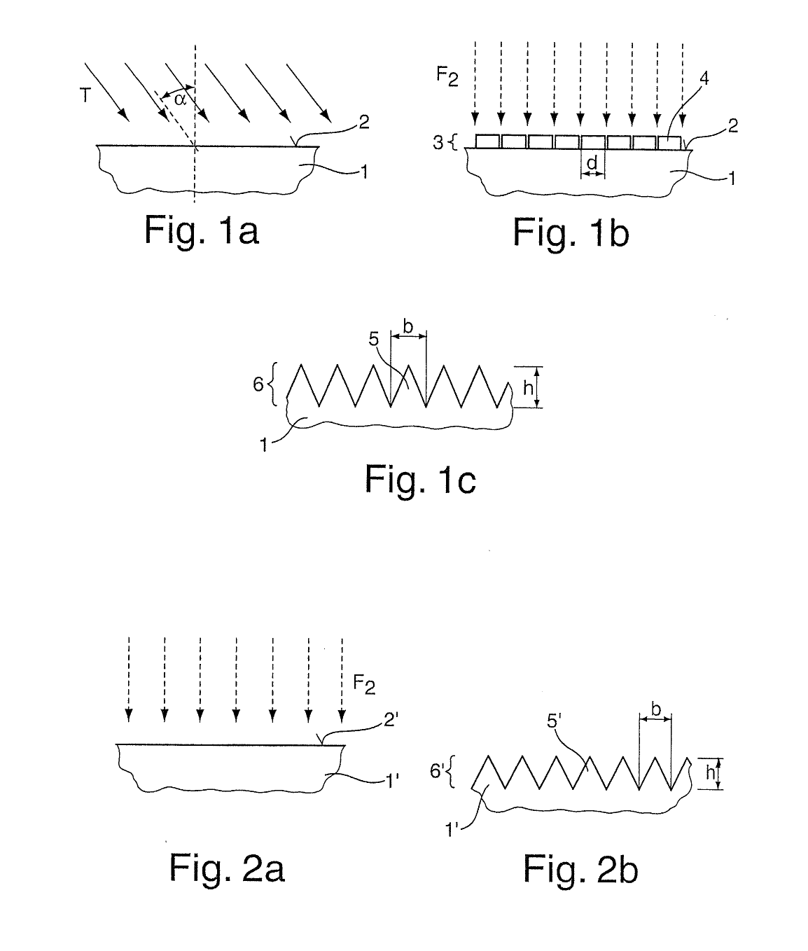

FIGS. 1a-c show several method-related steps for producing an antireflection surface on an optical element 1 made of fused silica (SiO₂), of which element 1 in each case only a partial region is shown in a sectional view in FIGS. 1a-c. In the present case the optical element 1 is a terminating plate for a projection lens (not shown) of a projection exposure apparatus for microlithography. The projection lens and thus also the optical element 1 are operated at a useful-light wavelength λ, of 193 nm.

In order to produce the antireflection surface, as shown in FIG. 1a, in a first step magnesium fluoride (MgF₂) is vapor deposited onto the optical element 1 at a coating temperature T of 573 K, wherein the magnesium fluoride is applied at an angle of incidence of α=20° on a surface 2 of the optical element 1, which surface 2 is to be coated, at a suitable vapor deposition rate (arrows in FIG. 1a), where it forms a coating 3 as shown in FIG. 1b. The magnesium fluoride coating has a columnar coating structure with column diameters d averaging approximately 10-20 nm, which are thus significantly smaller than the useful-light wavelength λ of 193 nm. Dielectric materials such as neodymium fluoride (NdF₃), lanthanum fluoride (LaF₃), gadolinium fluoride (GdF₃), erbium fluoride (ErF₃), cryolite (Na₃AlF₆), chiolite (Na₅Al₃F₁₄), aluminium fluoride (AlF₃) or aluminium oxide (Al₂O₃) are further materials that can form nanostructures on a surface comprising fused silica. All these materials are transparent to UV radiation at the useful-light wavelength of 193 nm.

As shown in FIG. 1b, the layer 3 comprising magnesium fluoride (MgF₂) in a directed fluorine plasma with fluorine as the etching gas serves as an etching mask for the underlying fused silica substrate of the optical element 1, which is etched by the fluorine plasma. Etching of the fused silica substrate of the optical element 1 takes place along the grain boundaries of the MgF₂ coating, which grain boundaries serve as etching channels, wherein for the production of an aspect ratio of greater than one the set direction of the fluorine plasma results in anisotropic etching. It is understood that for the purpose of etching it is also possible to use other etching gases, e.g. hydrogen fluoride (HF) or sulphur hexafluoride (SF₆). Likewise, instead of using a plasma beam for etching, an ion beam can be used.

As a result of etching away the fused silica substrate of the optical element 1, the layer 3 collapses and loses its adherence to the substrate. The surface structure resulting from this process has a monotonic gradient of the refractive index, diagrammatically shown as conical sub-lambda structures 5 in FIG. 1c. In the etching process, residues of the layer 3 may remain in some locations. However, the above-mentioned coating materials are transparent to radiation at the useful-light wavelength, so that the residues do not absorb the useful light. As a rule, the size of the residues is clearly below the useful-light wavelength, so that said residues only make an insignificant contribution to producing stray light.

The regularly distributed sub-lambda structures 5 that remain after etching form a surface relief, thereby producing an antireflection surface 6 on the optical element 1. The antireflection surface 6 is given its reflection-reducing effect in that the sub-lambda structures 5 approximate an ideal gradient coating. It is understood that for this purpose the sub-lambda structures 5 do not necessarily have to have the shape shown in FIG. 1c. Other shapes, for example pyramid-like shapes or hemispherical shapes, can also be used for this, and if necessary can be produced when selecting the process parameters in a different way. However, a binary structure of the antireflection surface, i.e. essentially cuboid sub-lambda structures, should be avoided because the latter do not result in a continuous transition in the refractive index between the optical element 1 and the environment, typically air or a vacuum.

In the case shown in FIG. 1c, the structural width b that corresponds to the period length of the surface relief of the sub-lambda structures 5 is 80 nm, i.e. it approximately corresponds to 0.4 times the useful-light wavelength λ. The structural height h of the sub-lambda structures 5 is 240 nm; it thus corresponds to 1.2 times the useful-light wavelength λ. The sub-lambda structures of FIG. 1c therefore have an aspect ratio of 3, in which even in the case of high angles of incidence of up to 70° a reflectivity of the optical element 1 of less than 2.5% can be achieved, wherein up to 60° the reflectivity is still below 0.5%. In particular, even in the case of angles of incidence of 60°, polarization splitting of the two polarization components (s-polarized and p-polarized light) is considerably reduced.

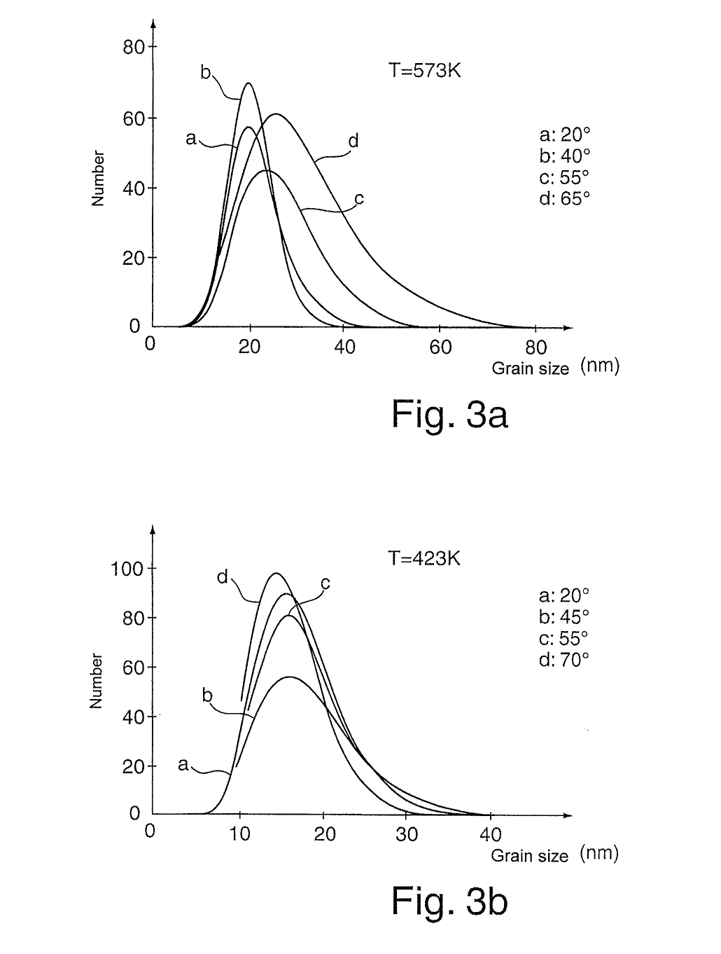

In the method for producing the antireflection surface 6, which method has been described above with reference to FIGS. 1a-c, it has been assumed that the diameter d of the nanostructures 4 of the coating 3 is constant. It is understood that the diameter d is only an average value, because the nanostructures 4 comprise a structural-width distribution that depends on process control during vapor deposition. FIGS. 3a,b show the number of the nanostructures 4 which in a size range of between 0 nm and approximately 80 nm have been determined using atomic force microscope (AFM) images, namely for a vapor deposition temperature of 573 K (FIG. 3a) or of 423 K (FIG. 3b). The diagrams clearly show that the grain size distribution or the structural-width distribution at the lower vapor deposition temperature of 473 K is essentially limited to a size range of approximately 5 nm to approximately 40 nm. Apart from the vapor deposition temperature T, as a further vapor deposition parameter the vapor deposition angle α and/or the rate of coating can be varied, as a result of which the width of the grain size distribution and the position of the maximum of the distribution can be varied. FIGS. 3a,b each show four typical structural-width distributions a to d in the case of vapor deposition angles of a: 20°, b: 40°, c: 55° and d: 65° (FIG. 3a) or a: 20°, b: 45°, c: 55°, d: 70° (FIG. 3b).

With a suitable selection of the vapor deposition parameters a situation can be achieved in which the structural-width distribution remains limited to a region below approximately 80 nm, which approximately corresponds to 0.4-times the useful-light wavelength λ. Preferably, fewer than 0.1%, in particular no, nanostructures are present in the coating 3 that has a structural width above this value. In this way it is possible to ensure that the sub-lambda structures 5 being formed using the nanostructures 4 comprise structural widths of 80 nm or less.

It is understood that the sub-lambda structures 5 have a distribution that corresponds to the structural-width distribution of the nanostructures 4. The occurrence of such a distribution is unproblematic if it is ensured that the sub-lambda structures are distributed essentially evenly on the surface of the optical element 1, i.e. typically over a diameter of between approximately 100 and 300 mm. The evenness of the distribution on the surface can best be determined by way of power spectral density (PSD) measurement, in which the roughness of the surface is plotted depending on the local wavelength. In an ideal case, in PSD measurements, below the useful-light wavelength λ the surface comprises (band-limited) roughness values (also designated “root mean square values”) that are high in a targeted manner, while at local frequencies above the useful-light wavelength λ the RMS values should if possible be the same as in the case of a surface that does not comprise any structuring in the sub-lambda region. In the case of irregularly applied sub-lambda structures, high (band-limited) RMS values also occur above the useful-light wavelength, which gives rise to stray light.

As an alternative to the method described above with reference to FIGS. 1a-c it is also possible to produce an antireflection surface without the use of a nano-structured coating as an etching mask, as will be explained below with reference to FIGS. 2a,b. To this effect, as shown in FIG. 2a, a manually pre-cleaned optical element 1′ made of fused silica (Suprasil) is anisotropically etched in a fluorine atmosphere using a plasma beam with fluorine provided as an etching gas. In this arrangement the fluorine atmosphere has a temperature of 150° C. at a pressure of approximately 2 to 3×10⁻⁴ mbar. As a result of anisotropic etching, an antireflection surface 6′ is formed on the optical element 1, wherein the reflection-reducing effect achieved in experiments conducted so far is less than that in the case of structuring when using an etching mask.

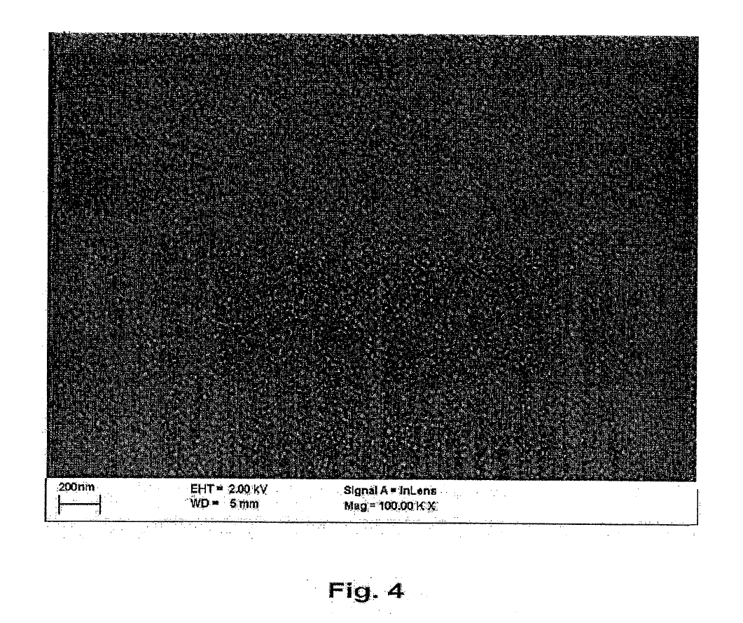

In the above case it has been shown that as a result of self-organisation, sub-lambda structures 5′ with a structural width b of a maximum of approximately 20 nm are formed, which in FIG. 4 are shown in a top view of a Suprasil surface. The sub-lambda structures 5′ produced have an aspect ratio of approximately 0.2 and a structural height of approximately 4 nm. The aspect ratio of the sub-lambda structures 5′ is thus 0.2. However, with a suitable selection of the etching parameters, other structures and aspect ratios can also be set. It is understood that for anisotropic etching, apart from fluorine, the etching gases stated further above can also be used, and that, apart from fused silica, other materials can also be provided with an antireflection surface using the mask-less method.

In summary, with the method presented above, reduced reflection of optical elements can be effectively achieved in that said optical elements are provided with sub-lambda structures, which approximate an ideal gradient layer. It is understood that it is not only the terminating plate described above that can undergo such reduced reflection, but that the same effect can also be achieved with other optical elements, for example for gratings, lenses, diffraction structures, computer-generated holograms (CGHs), and in refractive micro-optical elements, e.g. in the form of spherical or aspherical micro-lenses. These optical elements can be used in projection optics or illumination systems of projection exposure apparatuses for microlithography or in other optical arrangements.

The above description of the preferred embodiments has been given by way of example. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

1. A method for producing an antireflection surface on an optical element made of a material that is transparent at a useful-light wavelength λ, in the ultraviolet region, comprising:
applying a layer of an inorganic, non-metallic material, which forms nanostructures and is transparent to the useful-light wavelength λ, onto an initial surface of the optical element; and
etching the surface with the nanostructures of the layer as an etching mask, thereby forming sub-lambda structures in the initial surface.

2. The method according to claim 1, further comprising selecting a dielectric material as the material that forms the nanostructures; and
wherein the sub-lambda structures are shaped substantially as at least one of pyramids and cones.

3. The method according to claim 1, further comprising selecting the material that forms the nanostructures from the group consisting of: magnesium fluoride (MgF₂), neodymium fluoride (NdF₃), lanthanum fluoride (LaF₃), gadolinium fluoride (GdF₃), erbium fluoride (ErF₃), cryolite (Na₃AlF₆), chiolite (Na₅Al₃F₁₄), aluminium fluoride (AlF₃) and aluminium oxide (Al₂O₃).

4. The method according to claim 1, wherein the layer is applied onto the surface of the optical element by vapor deposition, wherein at least one vapor deposition parameter selected from the group consisting of: deposition angle (α), vapor deposition rate and vapor deposition temperature (T) is selected such that a desired structural-width distribution of the nanostructures is obtained.

5. The method according to claim 4, wherein the vapor deposition parameters selected such that a structural-width distribution results in which less than 1% of the nanostructures comprise a structural width that is greater than the useful-light wavelength λ.

6. The method according to claim 1, wherein said etching of the surface comprises plasma etching or ion beam etching.

7. A method for producing an antireflection surface on an optical element made of a material that is transparent at a useful-light wavelength 2 in the ultraviolet region, comprising:
plasma- or ion beam etching an initial surface of the optical element in a gas atmosphere so as to produce the antireflection surface by forming sub-lambda structures in the initial surface.

8. The method according to claim 7, wherein the gas atmosphere is formed by at least one gas selected from the group consisting of: fluorine (F₂), hydrogen fluoride (HF), sulphur hexafluoride (SF₆), xenon difluoride (XeF₂), nitrogen trifluoride (NF₃) and perfluorinated hydrocarbons.

9. The method according to claim 7, further comprising selecting the pressure of the gas atmosphere to be between 10⁻¹ mbar and 10⁻⁶ mbar.

10. The method according to claim 7, further comprising selecting the temperature of the gas atmosphere to be between 15° C. and 400° C.

11. The method according to claim 1, further comprising, for said etching, selecting an etching gas from the group consisting of: fluorine (F₂), hydrogen fluoride (HF), sulphur hexafluoride (SF₆), xenon difluoride (XeF₂), nitrogen trifluoride (NF₃) and perfluorinated hydrocarbons.

12. The method according to claim 1, wherein the sub-lambda structures are produced with a structural width of at most 100 nm.

13. The method according to claim 1, wherein the sub-lambda structures are produced with a structural height of at least 100 nm.

14. The method according to claim 7, further comprising, for said etching, selecting an etching gas from the group consisting of: fluorine (F₂), hydrogen fluoride (HF), sulphur hexafluoride (SF₆), xenon difluoride (XeF₂), nitrogen trifluoride (NF₃) and perfluorinated hydrocarbons.

15. The method according to claim 7, wherein the sub-lambda structures are produced with a structural width of at most 100 nm and a structural height of at least 100 nm.

16. An optical element for a useful-light wavelength λ, in the ultraviolet region, comprising at least one antireflection surfacehaving sub-lambda structures.

17. The optical element according to claim 16, at an angle of incidence of at most 50°, the antireflection surface has a reflectivity of less than 1%.

18. The optical element according to claim 16, wherein the sub-lambda structures have a structural width of at most 100 nm.

19. The optical element according to claim 16, wherein the sub-lambda structures have a structural height of at least 100 nm.

20. A projection exposure apparatus for microlithography, comprising at least one optical element according to claim 16.

21. The optical element according to claim 16, wherein, for radiation at the useful-light wavelength λ, and at an angle of incidence of at most 50°, the antireflection surface has a reflectivity of less than 1%.

22. The optical element according to claim 16, wherein the material of the optical element is fused silica (SiO₂).
